(19) United States
(12) Patent Application Publication
(10) Pub. No.: US 2023/0318391 A1
(43) Pub. Date: Oct. 5, 2023

(54) MOTOR UNIT

(71) Applicant: Nidec Corporation, Kyoto (JP)

(72) Inventors: Takashi HATTORI, Kyoto (JP); Yoshinobu ARAO, Kyoto (JP); Kenta SEKI, Kyoto (JP)

(21) Appl. No.: 18/124,008

(22) Filed: Mar. 21, 2023

(30) Foreign Application Priority Data
Mar. 31, 2022 (JP) 2022-058485

(51) Int. Cl. H02K 5/10; H02K 11/30; H02K 1/22

(52) U.S. Cl. CPC H02K 5/10; H02K 11/30; H02K 1/22

(57) ABSTRACT

A motor assembly includes a motor, a board, and a housing. The housing includes a first housing including a board area, a second housing opposing the board area in a predetermined direction, and a seal sealing between the first housing and the second housing. The first housing includes an outer edge surrounding the board area and a recess recessed to an inward side from the outer edge along an inner periphery of the outer edge. The second housing includes a protrusion protruding to the inward side and located in the recess. The protrusion is an annular body partly including a discontinuity. The seal is located, at least partially, in the recess. The motor assembly further includes a blocking portion located in the first housing. The blocking portion blocks, at least partially, the discontinuity.

### CROSS-REFERENCE TO RELATED APPLICATIONS

The present application claims priority under 35 U.S.C. § 119 to Japanese Patent Application No. 2022-058485, filed on Mar. 31, 2022, the entire contents of which are hereby incorporated herein by reference.

### 1. FIELD OF THE INVENTION

The present disclosure relates to a motor assembly.

### 2. BACKGROUND

A conventional motor is accommodated in a housing. The housing includes a motor case and a cover. That is, the housing includes a plurality of members. The motor case has an opening. The opening of the motor case is covered with the cover.

When the housing is constituted by the plurality of members, in order to seal between the members constituting the housing, a sealing member is disposed between the members. However, depending on shapes of the members constituting the housing, a sealing effect of the sealing member may be insufficient.

### SUMMARY

A motor assembly according to an example embodiment of the present disclosure includes a motor including a rotor rotatable about a central axis and a stator radially opposing the rotor, a board connected to the motor, and a housing accommodating the motor and the board. The housing includes a first housing including a board area where the board is located, a second housing located to oppose the board area in a predetermined direction and covering the board from an outward side in the predetermined direction, and a seal sealing between the first housing and the second housing. The first housing includes an outer edge surrounding the board area when viewed in the predetermined direction, and a recess recessed to an inward side in the predetermined direction from the outer edge along an inner periphery of the outer edge. The second housing includes a protrusion protruding to the inward side and located in the recess. The protrusion is an annular body partly including a discontinuity when viewed in the predetermined direction. The seal is located, at least partially, in the recess. The motor assembly further includes a blocking portion located in the first housing. The blocking portion blocks, at least partially, the discontinuity.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a motor assembly according to an example embodiment of the present disclosure.

FIG. 2 is a sectional view of a motor according to an example embodiment of the present disclosure.

FIG. 3 is an exploded perspective view illustrating a positional relationship between a board and a housing according to an example embodiment of the present disclosure.

FIG. 4 is a perspective view of a first housing according to an example embodiment of the present disclosure from which a second housing is removed.

FIG. 5 is a perspective view of a busbar assembly according to an example embodiment of the present disclosure.

FIG. 6 is a sectional perspective view of the busbar assembly and a periphery thereof according to an example embodiment of the present disclosure.

FIG. 7 is a perspective view of a second housing according to an example embodiment of the present disclosure when viewed from an inward side.

FIG. 8 is a sectional perspective view of a second housing according to an example embodiment of the present disclosure.

FIG. 9 is a schematic view illustrating a sealing structure in a region where a protrusion exists between a first housing and a second housing according to an example embodiment of the present disclosure.

FIG. 10 is a schematic view illustrating a sealing structure in a region where a discontinuity exists between a first housing and a second housing according to an example embodiment of the present disclosure.

FIG. 11 is a plan view illustrating a positional relationship between a blocking portion and a discontinuity according to an example embodiment of the present disclosure.

FIG. 12 is a schematic view illustrating a sealing structure according to a modification of an example embodiment of the present disclosure.

### DETAILED DESCRIPTION

Hereinafter, example embodiments of the present disclosure will be described with reference to the drawings.

In the present specification, a direction in which a central axis CA of a motor 1 extends is simply referred to by the term “axial direction”, “axial”, or “axially”. A radial direction centered on the central axis CA is simply referred to by the term “radial direction”, “radial”, or “radially”. In the radial direction, a direction toward the central axis CA is simply referred to as “radially inside”, and a direction away from the central axis CA is simply referred to as “radially outside”. A circumferential direction about the central axis CA is simply referred to by the term “circumferentially”.

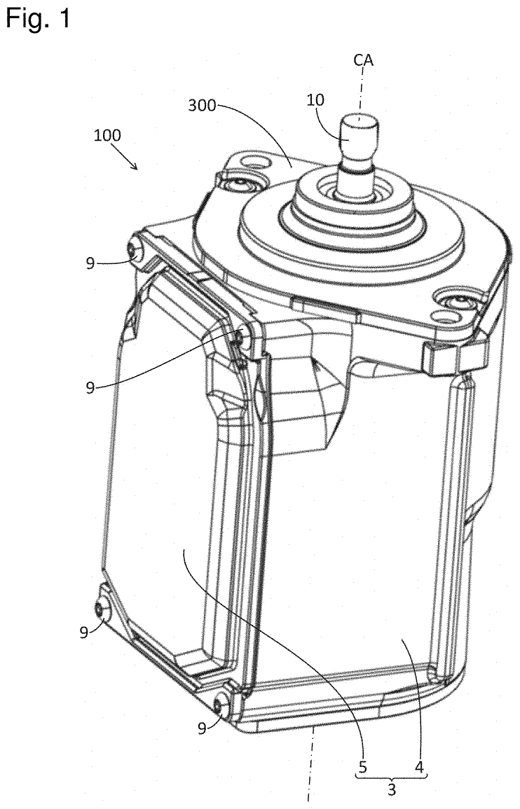

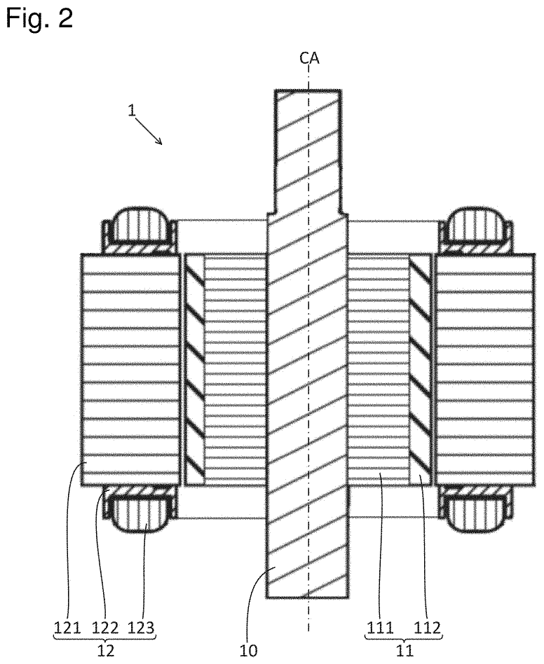

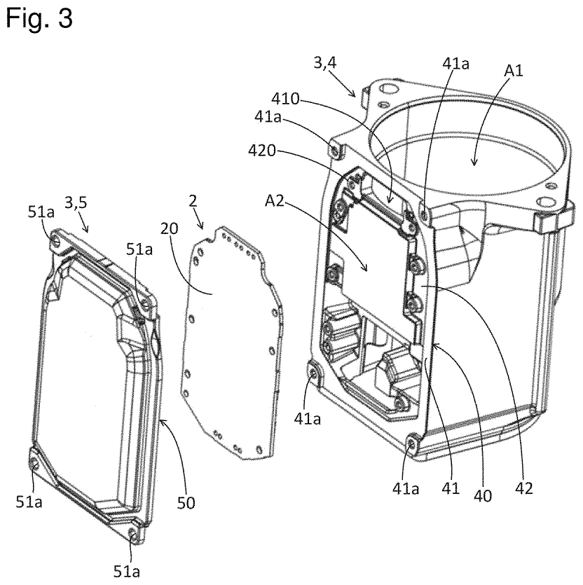

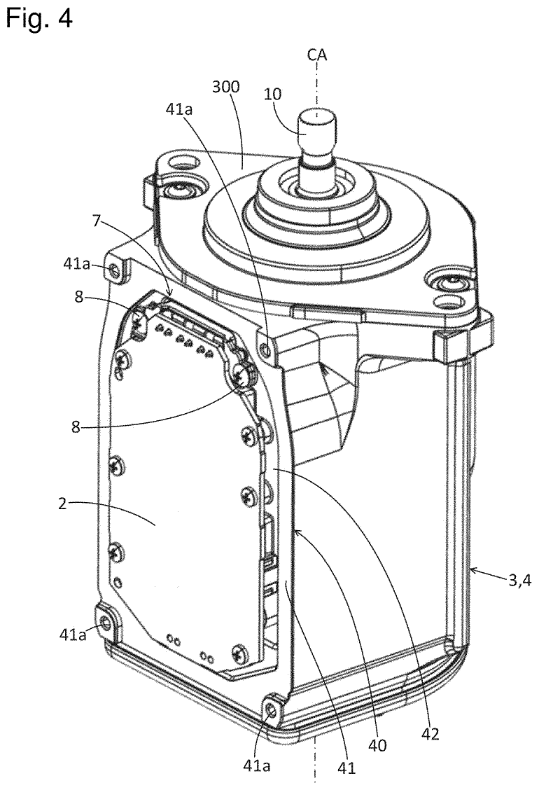

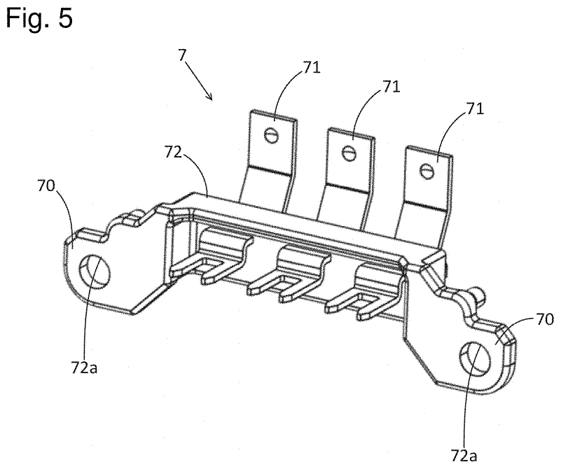

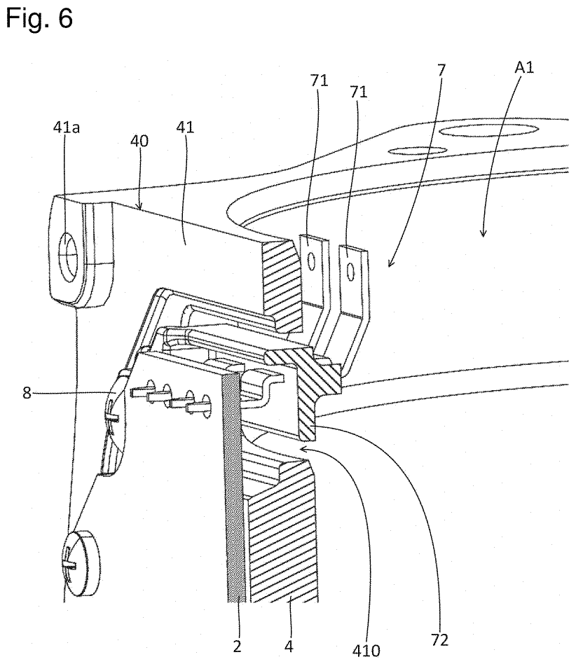

FIG. 1 is a perspective view of a motor assembly 100 according to an example embodiment. FIG. 2 is a sectional view of the motor 1 according to the example embodiment. FIG. 3 is an exploded perspective view illustrating a positional relationship between a board 2 and a housing 3 according to the example embodiment. FIG. 4 is a perspective view of a first housing 4 according to the example embodiment from which a second housing 5 is removed. FIG. 5 is a perspective view of a busbar assembly 7 according to the example embodiment. FIG. 6 is a sectional perspective view of the busbar assembly 7 and a periphery thereof according to the example embodiment.

The motor assembly 100 according to the present example embodiment includes the motor 1, the board 2, and the housing 3. The board 2 is connected to the motor 1. The housing 3 accommodates the motor 1 and the board 2.

The motor 1 includes a rotor 11 and a stator 12. The rotor 11 is rotatable about the central axis CA. The stator 12 radially faces the rotor 11. Specifically, the stator 12 is located radially outside the rotor 11. The motor 1 includes a shaft 10. The shaft 10 extends axially along the central axis CA. The shaft 10 is rotatably supported by a bearing (not illustrated). The shaft 10 forms a rotation shaft of the motor 1.

The rotor 11 includes a rotor core 111. The rotor core 111 has a cylindrical shape extending in the axial direction. The rotor core 111 is formed by stacking a plurality of electromagnetic steel plates in the axial direction. The shaft 10 is press-fitted into the rotor core 111. Consequently, the rotor core 111 is rotatable together with the shaft 10. A plurality of rotor magnets 112 are fixed to a radially outside surface of the rotor core 111. The plurality of rotor magnets 112 are circumferentially arranged.

The stator 12 includes a stator core 121, an insulator 122, and coils 123. The stator core 121 has an annular shape centered on the central axis CA. The stator core 121 is formed by stacking a plurality of electromagnetic steel plates in the axial direction. The rotor 11 is located radially inside the stator core 121.

The insulator 122 covers, at least partially, the stator core 121. Note that, the insulator 122 is an insulating member made of resin, for example. Each of the coils 123 is formed by winding a conductive wire around the stator core 121 through the insulator 122. The coils 123 are connected to the board 2.

The board 2 is a printed circuit board. The board 2 includes a mounting surface 20. An electronic component (not illustrated) is mounted on the mounting surface 20. The board 2 is located radially outside the motor 1. The mounting surface 20 is directed to the radial direction. The mounting surface 20 has a line extending in the radial direction as a normal line.

Note that, a normal direction of the mounting surface 20 corresponds to a “predetermined direction”. In the following description, the normal direction of the mounting surface 20 is referred to as the “predetermined direction”.

In the predetermined direction, a first side from the board 2 toward the motor 1 corresponds to an “inward side”, and a second side from the motor 1 toward the board 2 corresponds to an “outward side”. In other words, when viewed from the board 2, the “inward side” is an interior side (that is, a side toward the central axis CA) of the motor assembly 100, and the “outward side” is an exterior side (that is, a side away from the central axis CA) of the motor assembly 100. In the following description, the first side in the predetermined direction is referred to as the “inward side”, and the second side in the predetermined direction is referred to as the “outward side”.

The housing 3 includes the first housing 4. The first housing 4 has a motor area A1 where the motor 1 is located. Note that, the motor area A1 has an opening on an axial one side. The opening of the motor area A1 is covered with a bearing holder 300. The bearing (not illustrated) is fixed to the bearing holder 300. The bearing of the bearing holder 300 rotatably holds the shaft 10.

The first housing 4 has a board area A2 where the board 2 is located. The normal direction of the mounting surface 20 in a state where the board 2 is located in the board area A2 is the predetermined direction. The board 2 is located on the outward side with respect to the board area A2. The board 2 is fixed to the first housing 4 with screws (of which reference numeral is omitted).

The first housing 4 has a through hole 410. The through hole 410 penetrates from the motor area A1 to the board area A2. The motor 1 is connected to the board 2 through the through hole 410. In other words, the stator 12 is connected to the board 2 through the through hole 410.

The busbar assembly 7 is used for connection between the motor 1 and the board 2. That is, the motor assembly 100 includes the busbar assembly 7. The busbar assembly 7 includes busbars 71. The busbar assembly 7 also includes a busbar holder 72 that holds the busbars 71.

The busbars 71 are connected to the motor 1. The conductive wires constituting the coils 123 are drawn out from the stator 12, and the conductive wires are connected to the busbars 71. Note that, the stator 12 includes the coils 123 in a plurality of phases. The coils 123 in the plurality of phases are divided into three types of a U-phase coil 123, a V-phase coil 123, and a W-phase coil 123. Each of the coils 123 in the plurality of phases is connected to a corresponding one of the busbars 71. That is, the busbar assembly 7 includes three busbars 71.

One ends of the busbars 71 are located in the motor area A1 and connected to the motor 1. The other ends of the busbars 71 are located in the board area A2 and connected to the board 2. That is, the busbars 71 are drawn out from the motor area A1 to the board area A2 and connected to the board 2. The busbars 71 are drawn out from the motor area A1 to the board area A2 by being passed through the through hole 410.

The busbar holder 72 is made of resin. The busbar holder 72 is located in the board area A2. The busbar holder 72 holds the busbars 71 in the board area A2.

The first housing 4 has an arrangement part 420 in the board area A2. The busbar holder 72 is located in the arrangement part 420. The arrangement part 420 protrudes to the outward side from a bottom surface of a recess 42 to be described later. The arrangement part 420 has female threads extending in the predetermined direction. The busbar holder 72 has attachment holes 72a penetrating in the predetermined direction. Screws 8 are inserted into the attachment holes 72a from the outward side. The screws 8 are tightened to the arrangement part 420 in a state of being inserted into the attachment holes 72a. That is, the busbar holder 72 is fixed to the first housing 4 by the screws 8.

The board 2 is located on the outward side of busbar holder 72. The busbars 71 penetrate the busbar holder 72 in the predetermined direction. Thus, the busbars 71 are held in the board area A2. The other ends of the busbars 71 protruding out of the busbar holder 72 are connected to the board 2.

The housing 3 also includes the second housing 5. The second housing 5 is located to face the board area A2 in the predetermined direction. Then, the second housing 5 covers the board 2 from the outward side. In other words, the second housing 5 reduces entry of foreign matter such as moisture into the board area A2 and protects the board 2.

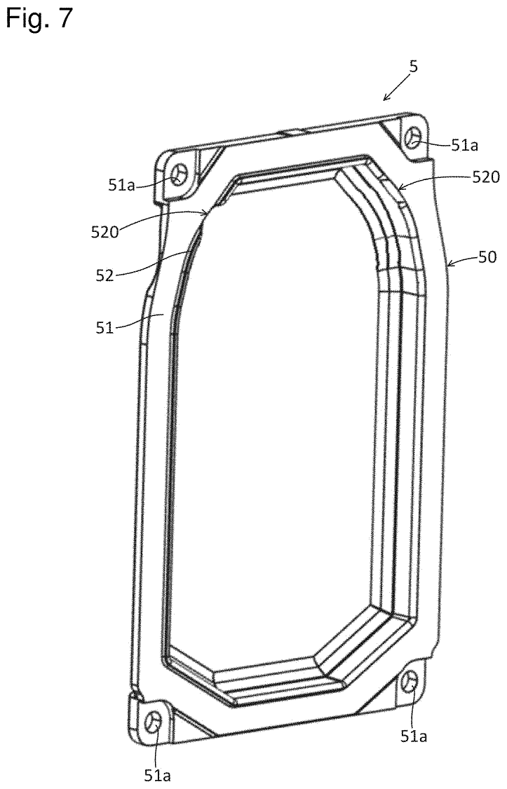

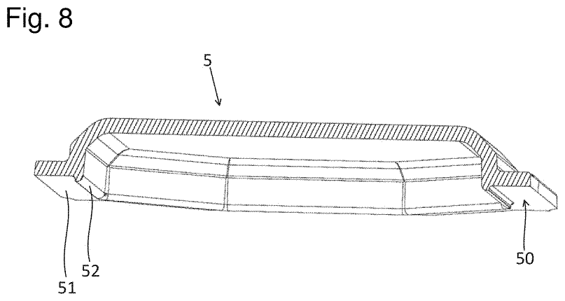

FIG. 7 is a perspective view of the second housing 5 according to the example embodiment when viewed from the inward side. FIG. 8 is a sectional perspective view of the second housing 5 according to the example embodiment.

The second housing 5 is fixed to the first housing 4. The second housing 5 is fixed to the first housing 4 by tightening of the screws.

Specifically, the first housing 4 has an outer edge 40 surrounding the board area A2 when viewed in the predetermined direction. The outer edge 40 has a flat surface 41. The flat surface 41 is orthogonal to the predetermined direction and directed to the outward side. That is, the first housing 4 has, in the outer edge 40, the flat surface 41 directed to the outward side. Note that, the flat surface 41 corresponds to a “first flat surface”. In the following description, the flat surface 41 is referred to as a first flat surface 41.

The first flat surface 41 has attachment parts 41a to which the second housing 5 is attached. The attachment parts 41a protrude from the first flat surface 41 to the outward side. The attachment parts 41a have female threads extending in the predetermined direction. The attachment parts 41a are located at four corners of the outer edge 40 when viewed in the predetermined direction.

The second housing 5 has an outer edge 50 facing the outer edge 40 of the first housing 4 in the predetermined direction when viewed in the predetermined direction. The outer edge 50 of the second housing 5 has a flat surface 51. The flat surface 51 is orthogonal to the predetermined direction and directed to the inward side. The flat surface 51 of the second housing 5 faces the first flat surface 41 in the predetermined direction. That is, the second housing 5 has the flat surface 51 directed to the inward side and facing the first flat surface 41 in the predetermined direction. Note that, the flat surface 51 corresponds to a “second flat surface”. In the following description, the flat surface 51 is referred to as a second flat surface 51. In addition, for sake of distinction, the outer edge 40 of the first housing 4 is referred to as a first outer edge 40, and the outer edge 50 of the second housing 5 is referred to as a second outer edge 50.

The second flat surface 51 has attachment holes 51a into which screws 9 are inserted. The second flat surface 51 is partly recessed to the outward side, and the attachment holes 51a are formed in the recessed portion. The attachment holes 51a are located at four corners of the second outer edge 50 when viewed in the predetermined direction. In other words, the attachment holes 51a face the attachment parts 41a in the predetermined direction. The screws 9 are tightened to the attachment parts 41a in a state of being inserted into the attachment holes 51a from the outward side. Here, a portion of the second housing 5 facing the board 2 in the predetermined direction is recessed to the outward side relative to the second outer edge 50. This can reduce contact between the electronic component mounted on the board 2 and the second housing 5.

Note that, in a state where the second housing 5 is fixed to the first housing 4, a gap is generated between the first flat surface 41 and the second flat surface 51. Although described in detail later, a seal 6 is located in the gap between the first flat surface 41 and the second flat surface 51.

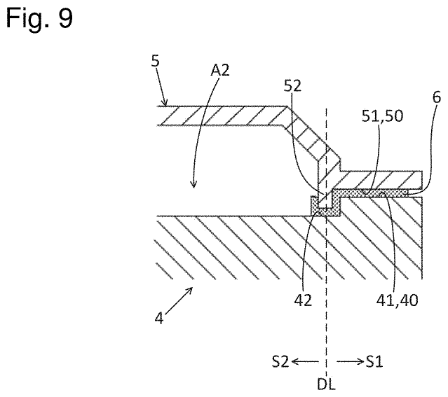

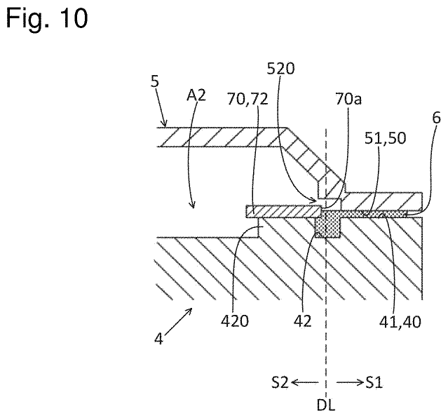

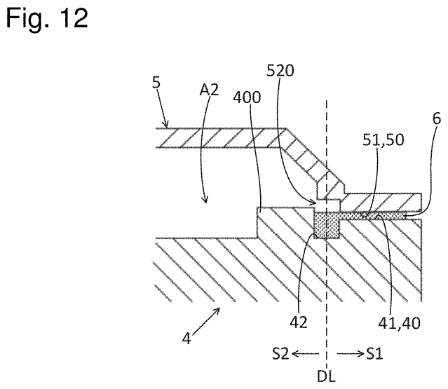

FIG. 9 is a schematic view illustrating a sealing structure in a region where a protrusion 52 exists between the first housing 4 and the second housing 5 according to the example embodiment. In FIG. 9, a side indicated by arrow S1 with respect to broken line DL is an exterior side of the protrusion 52, and a side indicated by arrow S2 with respect to the broken line DL is an interior side of the protrusion 52. An upper side of the drawing is the outward side, and a lower side of the drawing is the inward side. That is, a vertical direction in the drawing is the predetermined direction. The same applies to FIGS. 10 and 12 to be referred to in the following description.

The housing 3 includes the seal 6. The seal 6 seals between the first housing 4 and the second housing 5. That is, the seal 6 is located, at least partially, between the first housing 4 and the second housing 5. This reduces entry of the foreign matter such as moisture from the gap between the first housing 4 and the second housing 5. Note that, a constituent material of the seal 6 is not particularly limited. For example, a silicon-based adhesive can be used as the seal 6.

The seal 6 extends annularly and surrounds the board area A2 when viewed in the predetermined direction. This reduces entry of the foreign matter such as moisture into the board area A2. That is, the board 2 can be protected from the foreign matter such as moisture. Hereinafter, an arrangement position of the seal 6 will be specifically described.

The first housing 4 has the recess 42. The recess 42 is recessed to the inward side from the first outer edge 40 along the inner periphery of the first outer edge 40. The bottom surface of the recess 42 is orthogonal to the predetermined direction and directed to the outward side. That is, the first outer edge 40 protrudes to the outward side from the bottom surface of the recess 42. Similarly, the arrangement part 420 protrudes to the outward side from the bottom surface of the recess 42.

The second housing 5 has the protrusion 52 protruding to the inward side. The protrusion 52 protrudes to the inward side relative to the second flat surface 51. The protrusion 52 protrudes annularly. That is, the protrusion 52 is an annular body when viewed in the predetermined direction. However, although details will be described later, the annular body constituting the protrusion 52 partly has discontinuities 520 when viewed in the predetermined direction.

The protrusion 52 is located adjacent to the second outer edge 50 on the interior side of the second outer edge 50 when viewed in the predetermined direction. In other words, when viewed in the predetermined direction, the interior side of the second outer edge 50 is the protrusion 52.

In the state where the second housing 5 is fixed to the first housing 4, the protrusion 52 is located inside relative to the first outer edge 40 when viewed in the predetermined direction. Since the interior side of the first outer edge 40 is the recess 42 when viewed in the predetermined direction, the protrusion 52 is located in the recess 42. That is, the second housing 5 has the protrusion 52 protruding to the inward side and located in the recess 42.

Note that, in a process of assembling the first housing 4 and the second housing 5, the first flat surface 41 and the second flat surface 51 are overlapped in the predetermined direction in a state where the seal 6 is located on the first flat surface 41. At this time, since the seal 6 is flattened in the predetermined direction, the seal 6 flows toward the board area A2, and a part of the seal 6 reaches the recess 42. Consequently, the seal 6 is located, at least partially, in the recess 42.

Here, the protrusion 52 is located in the recess 42. Thus, the outflow of the seal 6 to the board area A2 is blocked by the protrusion 52. This can reduce an increase in outflow of the seal 6 to the board area A2 from the gap between the first flat surface 41 and the second flat surface 51. When the outflow of the seal 6 to the board area A2 from the gap between the first flat surface 41 and the second flat surface 51 is reduced, the sealing effect of the seal 6 between the first housing 4 and the second housing 5 is improved.

Note that, the seal 6 is located, at least partially, between the first flat surface 41 and the second flat surface 51, and extends from between the first flat surface 41 and the second flat surface 51 to the recess 42. Here, in the process of assembling the first housing 4 and the second housing 5, although the seal 6 flows out from the gap between the first flat surface 41 and the second flat surface 51 toward the recess 42, the outflow of the seal 6 is blocked by the protrusion 52 located in the recess 42, and thus the seal 6 tends to stay in the gap between the first flat surface 41 and the second flat surface 51. Thus, in the process of assembling the first housing 4 and the second housing 5, the seal 6 located between the first flat surface 41 and the second flat surface 51 can easily extend from between the first flat surface 41 and the second flat surface 51 to the recess 42 only by disposing the seal 6 on the first flat surface 41.

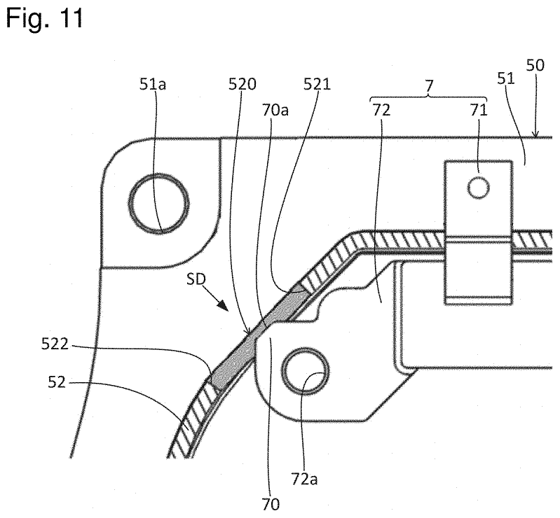

FIG. 10 is a schematic view illustrating a sealing structure in a region where the discontinuity 520 exists between the first housing 4 and the second housing 5 according to the example embodiment. FIG. 11 is a plan view illustrating a positional relationship between a blocking portion 70 and the discontinuity 520 according to the example embodiment. In FIG. 11, the protrusion 52 is indicated by hatching, and the discontinuity 520 is indicated by being thinly colored.

The protrusion 52 is an annular body partly having the discontinuity 520 when viewed in the predetermined direction. That is, the protrusion 52 has an annular shape when viewed in the predetermined direction, and partly has a notch. Note that, in the following description, the exterior side of the protrusion 52 means the exterior side of the annular body when the protrusion 52 is viewed in the predetermined direction, and the interior side of the protrusion 52 means the interior side of the annular body when the protrusion 52 is viewed in the predetermined direction. The board 2 is located inside relative to the protrusion 52 when viewed in the predetermined direction.

In the configuration in which the discontinuity 520 is provided in the protrusion 52, the discontinuity 520 serves as a flow path of the seal 6 in the process of assembling the first housing 4 and the second housing 5. Thus, the amount of outflow of the seal 6 from the exterior side to the interior side of the protrusion 52 tends to be larger in the region where the discontinuity 520 exists than a region where the discontinuity 520 does not exist.

Thus, the motor assembly 100 includes the blocking portions 70. The blocking portions 70 are located in the first housing 4. Each of the blocking portions 70 is located inside, at a distance from the first outer edge 40, relative to the first outer edge 40 when viewed in the predetermined direction. Note that, when viewed in the predetermined direction, the interior side of the first outer edge 40 is the recess 42. That is, the blocking portion 70 protrudes to the outward side from the bottom surface of the recess 42.

The blocking portion 70 blocks, at least partially, the discontinuity 520. In other words, the protrusion 52 has an opening formed by the discontinuity 520. The opening penetrates between the exterior side and the interior side of the annular body as the protrusion 52. The opening serves as a flow path of the seal 6 from the exterior side to the interior side of the annular body as the protrusion 52, and the blocking portion 70 blocks, at least partially, the opening. In this configuration, in the process of assembling the first housing 4 and the second housing 5, even if the opening formed by the discontinuity 520 serves as the flow path of the seal 6, the seal 6 flowing out from the exterior side to the interior side of the protrusion 52 is blocked by the blocking portion 70. Thus, the seal 6 easily accumulates on the exterior side of the protrusion 52. In other words, the outflow of the seal 6 to the board area A2 from the gap between the first flat surface 41 and the second flat surface 51 is reduced, and the seal 6 easily stays in the gap between the first flat surface 41 and the second flat surface 51. As a result, the sealing effect of the seal 6 between the first housing 4 and the second housing 5 can be improved.

The blocking portion 70 is located in the first housing 4 at a position, at least partially, facing the discontinuity 520 in the predetermined direction. Consequently, in the state where the second housing 5 is fixed to the first housing 4, the blocking portion 70 is located in the discontinuity 520. That is, in the region where the discontinuity 520 exists, the blocking portion 70 functions in place of the protrusion 52. This results in further reduction of the outflow of the seal 6 to the board area A2 from the gap between the first flat surface 41 and the second flat surface 51.

The blocking portion 70 has a surface 70a that is orthogonal to the first flat surface 41 and directed to the exterior side of the protrusion 52 through the discontinuity 520. Consequently, the function of blocking the seal 6 can be easily provided to the blocking portion 70.

The surface 70a of the blocking portion 70 is parallel to the discontinuity 520 when viewed in the predetermined direction. In other words, the blocking portion 70 has the surface 70a parallel to the discontinuity 520 when viewed in the predetermined direction. Specifically, the surface 70a of the blocking portion 70 is parallel to a line connecting a first end 521 and a second end 522 of the discontinuity 520 in the direction in which the protrusion 52 extends when viewed in the predetermined direction (see FIG. 11). This configuration can further reduce the outflow of the seal 6 to the board area A2 from the exterior side to the interior side of the protrusion 52 because the surface 70a of the blocking portion 70 is located perpendicular to an outflow direction of the seal 6. In FIG. 11, a reference sign SD denotes the outflow direction of the seal 6.

The blocking portion 70 protrudes, at least partially, to the outward side relative to the first flat surface 41. Specifically, an outward-side end of the surface 70a of the blocking portion 70 is located on the outward side relative to the first flat surface 41. This can reduce the outflow of the seal 6 over the blocking portion 70 from the gap between the first flat surface 41 and the second flat surface 51 toward the board area A2. This results in further reduction of the outflow of the seal 6 to the board area A2 from the gap between the first flat surface 41 and the second flat surface 51.

Note that, the busbar holder 72 is located in the board area A2. That is, the busbar holder 72 is located inside relative to the first outer edge 40 when viewed in the predetermined direction. If the discontinuity 520 does not exist, a part of the busbar holder 72 comes into contact with the protrusion 52, which makes it difficult to attach the second housing 5 to the first housing 4. Thus, the protrusion 52 is the annular body partly having the discontinuity 520 when viewed in the predetermined direction. The discontinuity 520 serves as a portion that allows the busbar holder 72 to escape.

Here, in the configuration in which the discontinuity 520 is formed in the protrusion 52 in order to allow the busbar holder 72 to escape, the part of the busbar holder 72 is located in the discontinuity 520. Thus, the part of the busbar holder 72 is used as the blocking portion 70. That is, the blocking portion 70 is the part of the busbar holder 72. This eliminates the need to separately provide a dedicated member that functions as the blocking portion 70. That is, this can reduce an increase in the number of parts of the motor assembly 100.

The busbar holder 72 is located in the arrangement part 420. The arrangement part 420 is located on the interior side of the first outer edge 40 when viewed in the predetermined direction. Note that, the recess 42 is located on the interior side of the first outer edge 40. That is, the first housing 4 has, in the recess 42, the arrangement part 420 in which the blocking portion 70 is located. Then, the arrangement part 420 protrudes to the outward side from the bottom surface of the recess 42. In this configuration, disposing the busbar holder 72 in the arrangement part 420 can easily bring about a state where the blocking portion 70 protrudes to the outward side relative to the first flat surface 41.

FIG. 12 is a schematic view illustrating a sealing structure according to a modification. FIG. 12 is a schematic view of a region where the discontinuity 520 exists between the first housing 4 and the second housing 5.

In the modification, the first housing 4 includes a blocking portion 400. The blocking portion 400 blocks, at least partially, the discontinuity 520.

Here, in the modification, the blocking portion 400 is the same member as the first housing 4. Specifically, the blocking portion 400 is a portion that is a part of the first housing 4 and protrudes to the outward side from the bottom surface of the recess 42. In other words, the blocking portion 400 is not retrofitted to the first housing 4. In other words, the blocking portion 400 is a portion integrally formed with the first housing 4.

In the modification, the seal 6 flowing out from the exterior side to the interior side of the protrusion 52 is blocked by the blocking portion 400. Thus, in the modification, similarly to the above example embodiment, the outflow of the seal 6 to the board area A2 from the gap between the first flat surface 41 and the second flat surface 51 is reduced, and the seal 6 easily stays in the gap between the first flat surface 41 and the second flat surface 51. As a result, the sealing effect of the seal 6 between the first housing 4 and the second housing 5 can be improved.

Furthermore, in the modification, the elimination of the need to attach the member including the blocking portion 400 to the first housing 4 can simplify a manufacturing process of the motor assembly 100.

The example embodiment of the present disclosure is described as above. Note that, the scope of the present disclosure is not limited to the above-described example embodiment. The present disclosure can be implemented with various modifications within a scope not departing from the gist of the disclosure. Furthermore, the above-described example embodiment and the modifications thereof can be appropriately and optionally combined.

The present disclosure can be applied to, for example, an electric power steering device used for assisting steering wheel operation of a vehicle such as an automobile.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor assembly comprising:
a motor including a rotor rotatable about a central axis and a stator radially opposing the rotor;
a board connected to the motor; and
a housing accommodating the motor and the board; wherein
the housing includes:
a first housing including a board area where the board is located;
a second housing opposite to the board area in a predetermined direction and covering the board from an outward side in the predetermined direction; and
a seal sealing between the first housing and the second housing;
the first housing includes:
an outer edge surrounding the board area when viewed in the predetermined direction; and
a recess recessed to an inward side in the predetermined direction from the outer edge along an inner periphery of the outer edge;
the second housing includes a protrusion protruding to the inward side and located in the recess;
the protrusion is an annular body partly including a discontinuity when viewed in the predetermined direction;
the seal is located, at least partially, in the recess;
the motor assembly further comprises a blocking portion located in the first housing; and
the blocking portion blocks, at least partially, the discontinuity.

2. The motor assembly according to claim 1, wherein the blocking portion is located in the first housing at a position, at least partially, opposing the discontinuity in the predetermined direction.

3. The motor assembly according to claim 1, wherein
the first housing includes, in the outer edge, a first flat surface directed to the outward side;
the second housing includes a second flat surface directed to the inward side and opposing the first flat surface in the predetermined direction; and
the seal is located, at least partially, between the first flat surface and the second flat surface, and extends from between the first flat surface and the second flat surface to the recess.

4. The motor assembly according to claim 3, wherein the blocking portion includes a surface that is perpendicular or substantially perpendicular to the first flat surface and directed to an exterior side of the protrusion through the discontinuity.

5. The motor assembly according to claim 3, wherein the blocking portion protrudes, at least partially, to the outward side relative to the first flat surface.

6. The motor assembly according to claim 5, wherein
the first housing includes, in the recess, an arrangement portion in which the blocking portion is located; and
the arrangement portion protrudes to the outward side from a bottom surface of the recess.

7. The motor assembly according to claim 1, wherein the blocking portion includes a surface parallel or substantially parallel to the discontinuity when viewed in the predetermined direction.

8. The motor assembly according to claim 1, further
comprising a busbar assembly; wherein
the first housing includes a motor area where the motor is located;
the busbar assembly includes:
a busbar connected to the motor, drawn out from the motor area to the board area, and connected to the board; and
a busbar holder holding the busbar in the board area; and
the blocking portion is a portion of the busbar holder.
